(19) United States
(12) Patent Application Publication
(10) Pub. No.: US 2006/0230386 A1
(43) Pub. Date: Oct. 12, 2006

(54) Defining and executing defaulting based on metadata definitions

(75) Inventor: Lars Dragheim Olsen, Karlslunde (DK)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/099,816

(22) Filed: Apr. 6, 2005

(51) Int. Cl. G06F 9/44

(52) U.S. Cl. 717/127

(57) ABSTRACT

A method and apparatus detects that when properties are changed within an entry a changed property is not defaulted by another changed property. The present invention determines what properties in the data have been changed. The present invention accesses a database to obtain the defaulting definitions for the properties that were changed. Then the present invention identifies, within each defaulting definition for a changed property, properties that it is dependent upon that are also being changed by the data. A defaulting table is generated based upon the defaulting definitions for the changed properties, and the defaulting logic is executed based on this table.

### BACKGROUND OF THE INVENTION

The present invention relates to the updating of data in a business solutions software program. More specifically, the present invention relates to controlling the order of defaulting properties when the data is provided from an outside source.

The current business environment is very different from what it was just a few years ago. Today's organizations embrace the global marketplace, and this dictates a need to be able to efficiently operate at all times. Customers are now more sophisticated which translates into an accelerated pace of business and decision-making processes. Further, business relationships have become highly dynamic, and customers expect businesses to adapt quickly.

Technical and operational challenges abound as well. There is a need to support multiple applications on a variety of platforms, and to integrate with companies using the Internet, extranets, business to business (B2B) exchanges, and other resources. Also, to effectively compete in today's market, there is a need to build new solutions on “Internet time,” utilizing open Internet standards and technology to assure maximum interoperability.

Businesses have typically used a variety of mechanisms to control and analyze business operations such as accounting, payroll, human resources, employee tracking, customer relations tracking, etc. Tools which provide these functions are often implemented using computer software. For example, a software package may manage business accounting, another software package might be responsible for receiving new orders, yet another software package will track warehouse inventory and still another package may handle order fulfillment and shipment. In another example, a business software package operated by one business will need to exchange data with a software package operated by another business to allow a business-to-business transaction to occur.

When business tools are implemented in software, it is not unusual for proprietary software packages to be responsible for each individual business task. However, this implementation is cumbersome and requires the same data to be entered in differing formats among the various business applications. In order to improve efficiency, integration applications have been developed which are used to integrate various elements of one business application with elements of another business application.

When developing solutions based on entities like Customers, Suppliers, Sales Orders, Items, these entities have properties, where defaulting dependencies exist between these properties. One property dependency is “defaulted” to another property when changes to the first property results in a change of value on the other property. Whether the new value is calculated or found does not matter, and whether the other property can be changed does not matter. It is still defaulted. For example, changing a “quantity” on a sales order line defaults a new “sales price” on the order line. When changing the sales price the extended price should also be calculated and defaulted.

The defaulting logic is most often hidden from the consumer of the entity, so the consumer need not do anything else than set the properties to the new values. But as in the above order line example in which the quantity defaults a new sales price, the consumer needs to be aware of this defaulting. In an example where the consumer needs to set both the quantity and the sales price, the consumer needs to set the quantity before the sales price, or else the sales price will be overwritten because of defaulting. This poses the problem that the consumer, when designing logic, needs to have knowledge of the defaulting dependencies, which are hidden from the consumer.

Another problem is that the implementation is also vulnerable to changes in the defaulting dependencies within an entity. These changes may result in properties that are set in an improper sequence in existing implementations. They will thus not produce the expected outcome.

Besides these problems, as shown in the above example, the extended price may be defaulted when both the quantity and the sales price are changed. Thus the extended price is defaulted twice. This might degrade performance, if the defaulting is resource consuming.

### SUMMARY OF THE INVENTION

The present invention is directed towards a method and apparatus for ensuring that when properties are changed within an entry a changed property is not defaulted by another changed property.

In one embodiment the present invention determines what properties in the data have been changed. These changes are stored in a table of changes that assists the present invention in determining which changed properties are dependent upon other changed properties. Next the present invention accesses a database to obtain the defaulting definitions where properties that were changed are dependent properties. Then the present invention identifies, within each defaulting definition for a changed property, properties that it is dependent upon that are also being changed by the data. If a changed dependent property is identified, the present invention can remove the dependent property from the defaulting definition when generating a defaulting tree for the changed entry. In one embodiment the present invention creates a prioritized table of properties which should be defaulted based on the properties which have been changed by the data. It prioritized table will leave out properties which have been changed by the data. The table is prioritized so that properties need only be defaulted once as it ensures that any dependent property for a property in the prioritized table is defaulted before the current property.

In an alternative embodiment, the present invention can reorder the data such that the changed property is changed after the property upon which it is dependent is changed.

### BRIEF DESCRIPTION OF THE DRAWINGS

FIG. 1 is a block diagram of one computing environment in which the present invention may be practiced.

FIG. 2 is a block diagram illustrating the components of a defaulting priority table generator according to one illustrative embodiment of the present invention.

FIG. 3 is a representation of the information contained within a defaulting definition according to one embodiment of the present invention.

FIG. 3A is an example of a metadata entry for a defaulting definition for the property of total price FIG. 4 is a diagrammatic representation of a dependency tree 400 for the properties of an order according to one illustrative embodiment of the present invention.

FIG. 5 is a flow diagram illustrating the steps executed by the present invention according to one embodiment.

FIG. 6 is a diagram of one defaulting definition according to one illustrative embodiment of the present invention.

FIG. 7 is a diagram of another defaulting definition according to one illustrative embodiment of the present invention.

### DETAILED DESCRIPTION OF ILLUSTRATIVE EMBODIMENTS

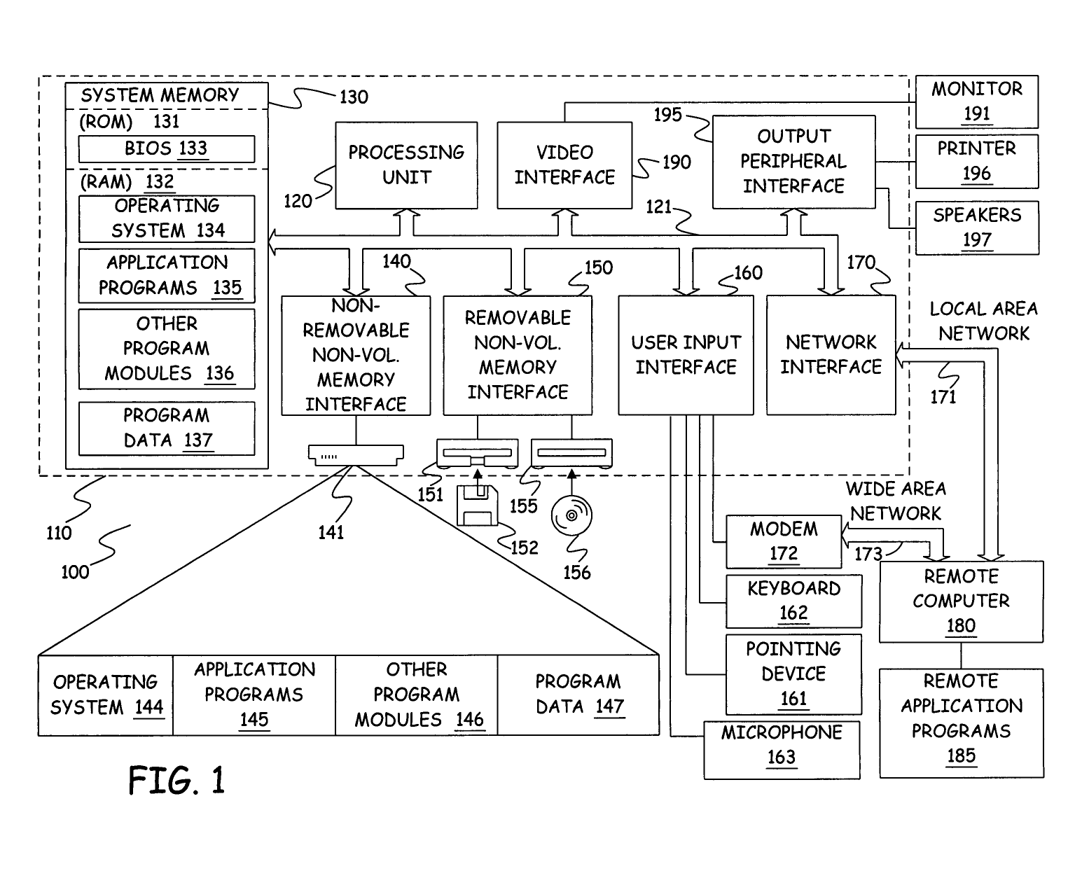

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

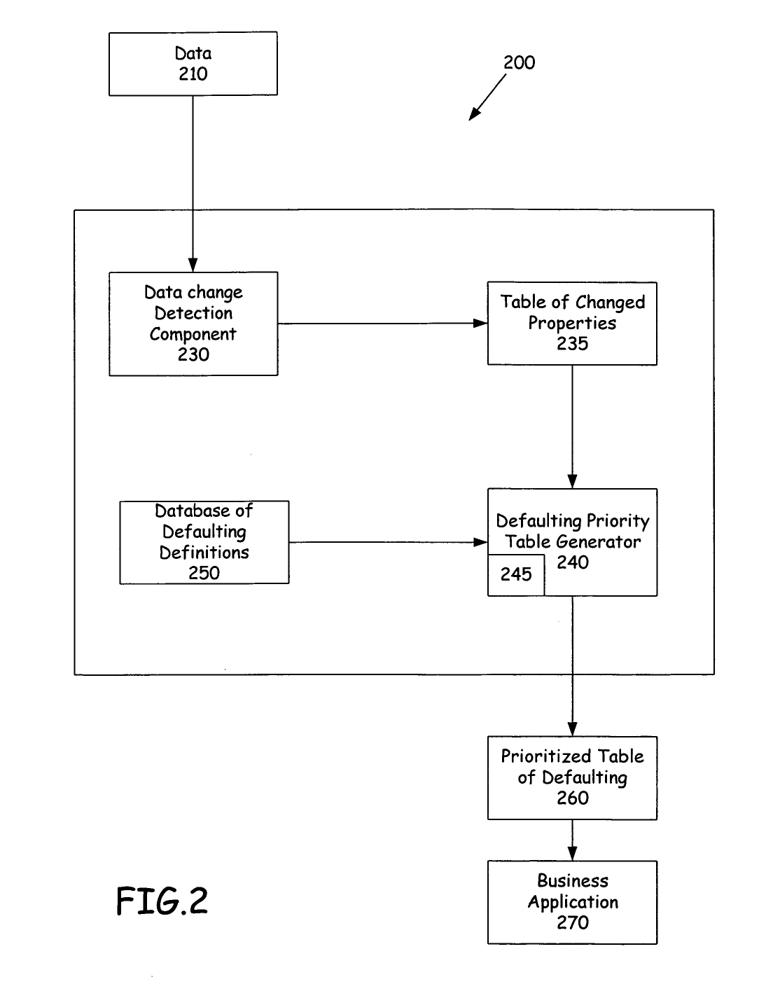

FIG. 2 is a block diagram illustrating the components of a prioritized table of defaulting generator 200 according to one illustrative embodiment of the present invention. The prioritized table of defaulting generator 200 includes a data change detection component 230, a defaulting priority table generator 240, and a database of defaulting definitions 250. These components work together to generate a prioritized table of defaulting 260 for the changed properties in an entry of data 210.

The prioritized table of defaulting generator 200 is activated when data 210 is received from a source outside of the application program 270. For example, this data 210 can come from other sources such as web pages, other application programs, direct entry into a table by a user, or stored data files. In one embodiment, data 210 is in XML (extended mark-up language). However, other languages and formats can be used for data 210.

For purposes of this discussion it will be assumed that the prioritized table of defaulting generator 200 is configured for an order management system. However, the present invention can be used on a vast array of customer management systems or other systems where data is updated and the system applies default rules to the properties within the entry.

Data 210 contains a number of fields or properties that delineate information, which is to be updated for various entries used by the application program. For example, in an order management system each entry can include information related to an item number, a quantity of the item, a definition of the minimum unit size, a price, an applicable discount and a total price for an order. Thus, an example of an XML entry for a single order can appear as illustrated below.

<?xml version=”1.0” encoding=”utf-8 ?>
<Order>

<OrderId>981454</Order>
<Item>982Y14</Item>
<Quantity>10</Quantity>
<UnitOfMeasure>Pcs</UnitOfMeasure>

</Order>

The data 210 is received by the data change detection component 230. Data change detection component 230 is configured to determine what properties have been changed in each entry, or if other data is provided for the entry. These detected changes are gathered or otherwise stored per entity in a list or table such as the table of changed properties 235 illustrated in FIG. 2. However, other storage methods can be used for storing the changes to the properties.

The table of changes is in one embodiment a data table that is created by the data change detection component 230 to keep track of the changes made to the order and the properties for the order. The order is identified by an entry in the table of changed properties 235. When multiple orders are changed each order has a separate entry in the table of changed properties 235. Each entry in the table of changed properties 235 is provided by the data change detection component 230 to the defaulting priority table generator 240.

When the user indicates that they are ready to allow the application 270 to apply the defaulting rules to the order the defaulting priority table generator 240 receives from the data change detection component 230 the table of changed properties 235. The defaulting priority table generator 240 in one embodiment includes a defaulting algorithm 245. The defaulting algorithm 245 obtains a set of defaulting definitions based on the properties which have been changed and the definitions where the changed properties are dependent properties. At the same time algorithm 245 leaves out the defaulting definitions where the defaulting property has been changed by the data.

The defaulting definitions for each property are stored in a defaulting definitions database 250. The defaulting definitions database 250 is in one embodiment a metadata store of associated properties for each of the properties that may be modified. However, other storage methods can be used, such as a pure in-memory database. The defaulting definitions define which properties are defaulted based on a change in other properties.

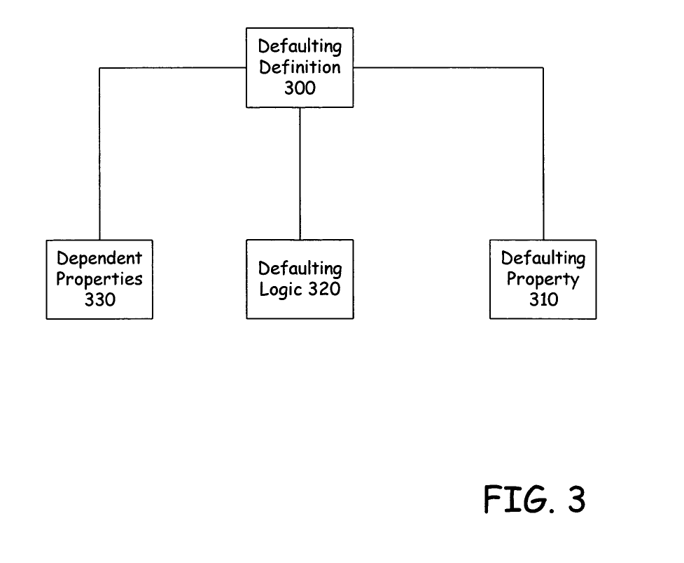

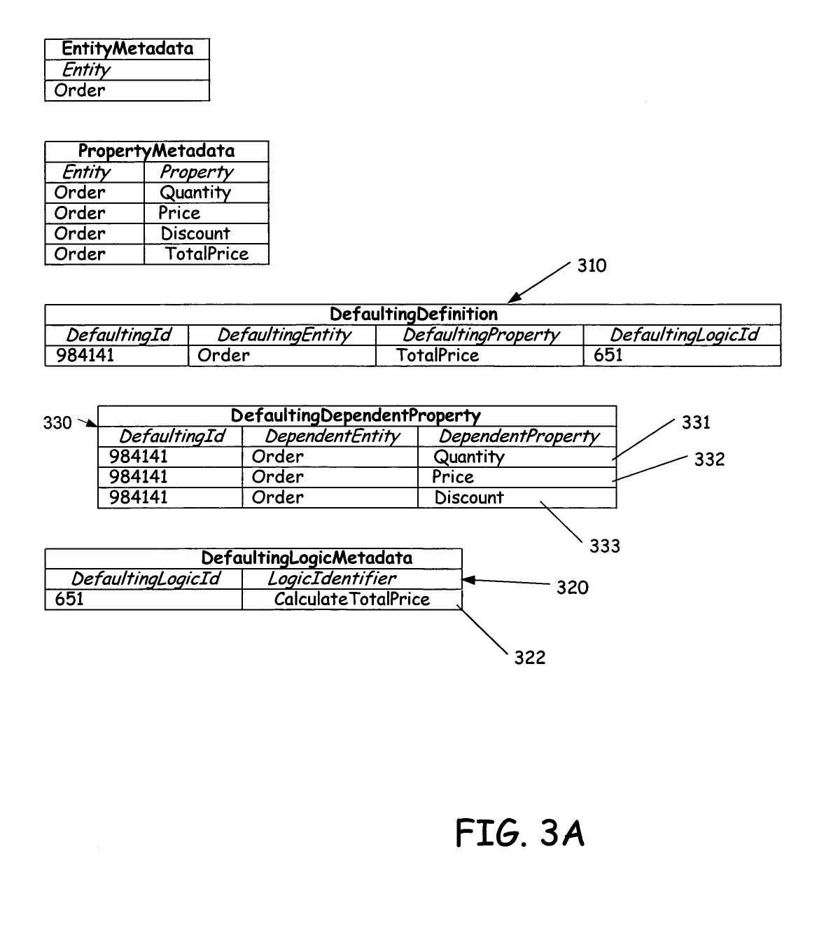

For example, FIG. 3 illustrates a representation of the information contained within a defaulting definition 300 according to one embodiment of the present invention. The defaulting definition 300 has three properties, a defaulting property 310, a defaulting logic 320, and a list of dependent properties 330. The defaulting definitions 300 are written or defined during the design of the program.

The defaulting property 310 is a property in the metadata that instructs the application as to which property is being defaulted (e.g. the “total price” property).

The defaulting logic 320 is a property in the metadata entry that instructs the application how to calculate the value of the defaulting property 310. For example, if the property being defaulted is the total price property then the defaulting logic may contain instructions for the application to take the value of the price property and multiply it by the value of the discount property. In another example, the logic 320 could include a look-up table, for instance.

The list of dependent properties 330 is a list of those properties that directly affect the present property when they are modified. This list is used by the defaulting priority table generator 240 to determine the order in which the properties must be modified to avoid defaulting a changed property.

An example of a metadata entry for a defaulting definition for the property of total price is illustrated in FIG. 3A. In this illustration the dependent properties of quantity, price and discount are illustrated by reference numbers 331, 332, and 333 respectively. The defaulting logic 320 includes the instructions or entry 322 for the logic to calculate the total price.

Based on the changes made to the properties, and the order of the properties in the data originally presented to the application, the defaulting priority table generator 240 creates a prioritized table of defaulting. The prioritized table of defaulting ensures that a property that is changed by the data is not overwritten, and the ordering ensures that a property is not defaulted to an incorrect value, because properties that it is dependent on is not yet defaulted. This protection against overwriting and reordering of properties is represented by the prioritized table of defaulting 260 in FIG. 2. The prioritized table of defaulting 260 is presented in a format expected by the application program 270. Thus, the user is able to update various properties in the system without having to have the extensive knowledge of the defaulting order and definitions that were set down at the time the application was originally written.

FIG. 4 is a diagrammatic representation of a dependency tree 400 consisting of all defaulting definitions for the properties of an order according to one illustrative embodiment of the present invention. The dependency tree 400 has properties corresponding to item 410, quantity of the item 420, unit of measure for the item 430, a price for the item 440, a discount for the item 450 and a total price for the order 460. Each property in the dependency tree 400 is dependent upon another property with the exception of item number 410.

Starting from the bottom of the tree 400 with the total price property 460 it is observed that the total price 460 is dependent upon the values of the properties for quantity 420, price 440 and discount 450. In other words, if any of these properties change the value of the property total price 460 would change or default according to an associated defaulting definition. The dependency on these values is illustrated by lines 426, 445 and 455.

The price property 440 is dependent upon the values for the properties of the item 410, the quantity 420, and the unit of measure 430. This dependency on these properties is illustrated by lines 415, 425 and 435. The discount property 450 is dependent upon the values for the same properties as the price property 440. This dependency is illustrated by lines 417, 427 and 437. The only difference in the properties of price and discount is the defaulting logic associated with each properties' defaulting definition.

The properties of quantity 420 and unit of measure 430 are dependent upon the value of the item property 410. This dependency is illustrated by lines 411 and 412. Once again the difference between these properties is in the defaulting logic associated with each of these properties defaulting definition.

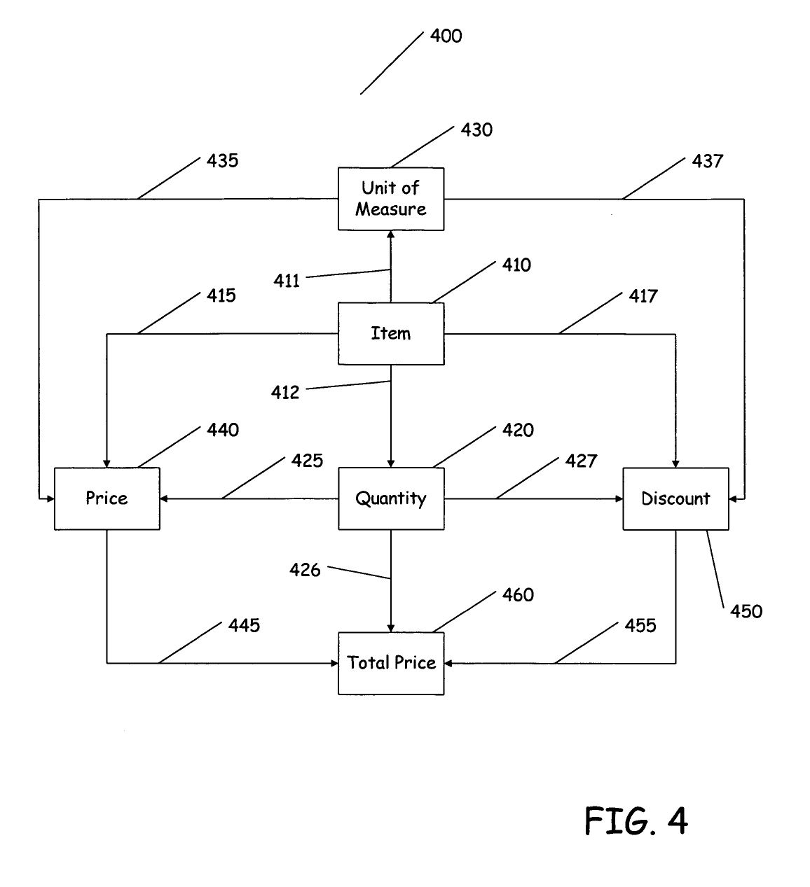

FIG. 5 is a flow diagram illustrating the steps executed by the present invention according to one embodiment. The first step in the process is for the data change detection component 230 to receive coded data that includes at least one change to one of the properties of the order. As discussed above this data can be in any format that is available to hold data. For example, the data change detection component 230 may receive the data from an update disc, an Internet site, a data file stored elsewhere, or any other data transmission method. Further, the properties of the data do not have to be in any particular order. This enables the user of the system to update the data without having to understand the entire defaulting structure of the application, and without having to understand the order in which the properties should be modified. The receipt of the data (or entry) at the application is illustrated by block 510.

Next the data is analyzed to determine what properties for the received entry have been changed. These changed properties are then stored in a table of changed properties 235. The purpose of the table of changed properties is to identify those properties that should not be defaulted when the application starts updating the information in the properties it currently has for the entry. The determination of what properties have been modified by the data is illustrated at step 520.

Once the changed properties have been identified by the generator 200 and placed in the table of changed properties 235, the generator 200 then accesses the defaulting definitions for all of the changed properties. The defaulting definitions that are obtained in the order example discussed above are the changed properties of quantity and price. Thus, the defaulting definitions for these two properties are gathered from database 250, and provided to the defaulting priority table generator 240.

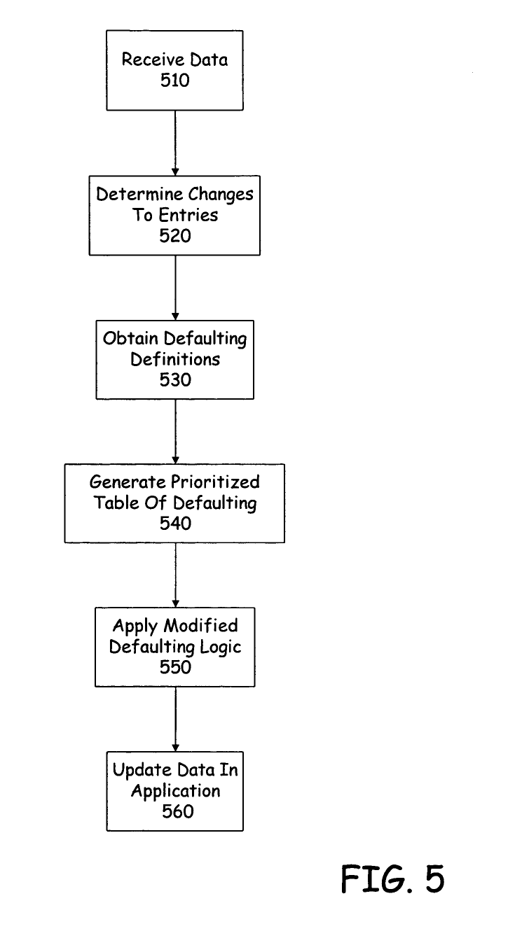

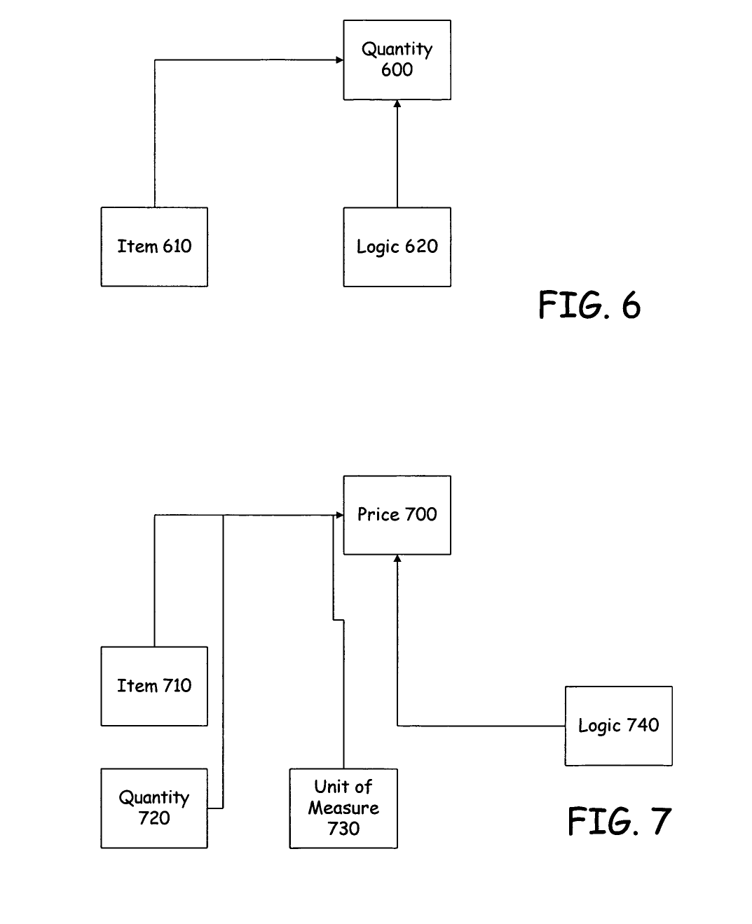

FIGS. 6 and 7 illustrate a tree diagram of the defaulting definition for these two changed properties according to one illustrative embodiment. In FIG. 6 the defaulting definition for the property of “quantity” is illustrated. This definition defines that quantity is dependent upon the values for the item 610, and a logic component 620. The logic component 620 in one embodiment defines the value of quantity based upon a predetermined minimum sales quantity.

FIG. 7 illustrates the defaulting definition for “price”. This definition defines that price is dependent upon the values for item 710, quantity 720, unit of measure 730 and a logic component 740. The logic component 740 is in one embodiment a look-up table based on the item number 710. The logic component 740 further considers the components of quantity 720 and unit of measure 730 in defaulting the price component. Obtaining the defaulting definitions is illustrated at step 530 of FIG. 5.

Once the defaulting definitions for the changed properties have been obtained the present invention develops a prioritized table of defaulting for the changed data. The prioritized table of defaulting instructs the application 270 in determining how the changed properties are to be applied. In an example where the properties of item, quantity and unit of measure are changed, the defaulting definitions for price, discount and total price will be obtained. For each property added to the prioritized table of defaulting 260, the defaulting definition database 250 is queried to obtain defaulting definitions where these newly added properties are dependent properties. These defaulting definitions are then also added to the prioritized table of defaulting 260. The obtaining of defaulting definitions continues until no new properties are added to the table. In alternative embodiment the generator 240 can remove the changed property from the dependency list of other changed properties.

In an example where only the property of item is changed, the defaulting definitions for the properties of price, discount, unit of measure, and quantity would be obtained as item is a dependent property of the defaulting definition for these properties. Thus, an example of the prioritized table of defaulting 260 for a change of the property of item would appear as illustrated in Table 1 below:

TABLE 1
TableOfPrioritizedDefaulting

| | |
|---|---|
| Order | Price |
| Order | Discount |
| Order | UnitOfMeasure |
| Order | Quantity |

Next the defaulting definitions where price is a dependent property are obtained. This will return the definition for total price and this property is added to the prioritized table of defaulting 260. This results in Table 1 being modified as exemplified by Table 2 illustrated below:

TABLE 2
PrioritizedTableOfDefaulting

| | |
|---|---|
| Order | Price |
| Order | Discount |
| Order | UnitOfMeasure |
| Order | Quantity |
| Order | TotalPrice |

Then the database 250 is examined for definitions where discount is dependent property. This also returns the definition for total price, but as this property is already in the prioritized table of defaulting 260, it is not added to the table.

Then the remaining properties in the prioritized table of defaulting 260 (unit of measure, quantity and total price) are analyzed. The analysis of the unit of measure and quantity properties will only lead to the obtainment of definitions which are already in the table 260, and as no definitions are dependent on the total price property, no additional properties are added to the prioritized table of defaulting 260.

When the prioritized table of defaulting 260 is complete, it may be sorted by priority, so that properties, that are dependent properties for other properties in the table, have higher priority. However, in other embodiments the table is not sorted, but other methods of indicating the defaulting order are added to the table.

In the above example as the property unit of measure is a dependent property for both the properties of price and discount, the entry in the table for unit of measure is given a higher priority than the entry for price and discount. The same goes for the entries for quantity as both the properties of discount and price have a dependency on the quantity property. The property of total price is dependent on quantity, price and discount, so it is given a lower priority than these properties. This results in a prioritized table of defaulting 260 such as Table 3 illustrated below. Table 3 has been prioritized. As discussed above the table may be sorted or it may be number. However, as long as the business application 270 is able to understand the priority any method can be used.

TABLE 3
PrioritizedTableOfDefaulting

| | | |
|---|---|---|
| 1 | Order | UnitOfMeasure |
| 2 | Order | Quantity |
| 3 | Order | Price |
| 4 | Order | Discount |
| 5 | Order | TotalPrice |

This process of creating the prioritized table of defaulting is illustrated at step 540.

When the prioritized table of defaulting 260 has been prioritized the generator 200 proceeds to enter the data into the system and the defaulting logic is executed for each property in the table and it is executed in order of priority. This is illustrated at step 550.

However, in one embodiment prior to the execution of the defaulting logic the table 260 is analyzed to determine that at least one of the dependent properties is in the table of changed Properties 235, and when the defaulting logic is executed and the defaulted property is changed, the property is added to the table of changed properties 235.

So, for example, prior to the execution of the defaulting logic for the property of unit of measure, the generator 200 determines if one of the dependent properties (which in this case is only item) is in the table of changed properties 235. As item is in the table, the defaulting logic for unit of measure is executed. If this execution leads to a change of unit of measure, then unit of measure is added to the table of changed properties 235. This process continues for each of the remaining properties that are dependent upon the property of item. The defaulting logic for the property of total price will only be executed if there is an entry for price, quantity or discount in the table of changed properties 235. This will only be the case if the defaulting logic for price, quantity and discount respectively, actually changed the value of any of these properties, or if these properties were changed by the data entry.

Following the defaulting of the non-changed properties at step 550, the application proceeds to store the data at step 560. In one embodiment storage of the data conforms to the storage technique normally used by the application 270 to store this data. However, in alternative embodiments step 560 can be omitted.

It can thus be seen that the present invention enables users of the business application 270 to update entries in the application from files or other passive data entry mechanisms without having to understand the underlying business logic for the process.

Although the present invention has been described with reference to particular embodiments, workers skilled in the art will recognize that changes may be made in form and detail without departing from the spirit and scope of the invention.

What is claimed is:

1. A method for identifying data to be changed in a business application having an entry with a plurality of properties and a set of defaulting rules for each of the plurality of properties, comprising:
receiving data at the application;
determining which properties have changed in the data;
obtaining a defaulting definition for each of the properties that have changed; and
generating a defaulting table for the data.

2. The method of claim 1 and further comprising:
defaulting the data based on the generated defaulting table.

3. The method of claim 1 wherein generating a defaulting table further comprises:
identifying those properties having a defaulting definition that includes a dependency on another property that has been changed

4. The method of claim 1 wherein generating a defaulting table further comprises:
removing from the defaulting tree any property that have been changed by the data.

5. The method of claim 1 wherein generating a defaulting table further comprises:
reordering the properties in the data based on the identified properties.

6. The method of claim 5 wherein in reordering the properties orders the properties such that the properties are changed in an order consistent with an original defaulting order.

7. The method of claim 1 wherein the defaulting definitions are in metadata.

8. The method of claim 1 wherein the defaulting table is a data representation of a defaulting order.

9. The method of claim 1 wherein the defaulting definition for a property contains information indicating which property the property is dependent upon.

10. The method of claim 1 wherein the data has a plurality of property changes for an entry.

11. A business application configured to be updated by data having at least one entry including a plurality of properties and a least one change to one of the plurality of properties, comprising:
a data change detection component configured to determine which properties in the entry have been modified;
a data store of defaulting definitions for each of the properties; and
a defaulting table generator configured to ensure that a first changed property is not changed by another changed property.

12. The business application of claim 11 wherein the defaulting definitions for each property contain information indicating which properties the defaulting property is dependent upon.

13. The business application of claim 12, wherein the defaulting definitions are configured in metadata.

14. The business application of claim 11 wherein the defaulting table generator is configured to determine which properties are dependent on other changed properties.

15. The business application of claim 14 wherein the defaulting table generator is configured to remove another changed property.

16. The business application of claim 14 wherein the defaulting table generator is configured to reorder the data such that a changed property that is dependent upon another changed property is changed after the another changed property.
